(19) United States
(12) Patent Application Publication
(10) Pub. No.: US 2023/0357652 A1
(43) Pub. Date: Nov. 9, 2023

(54) REMOVING IMPURITIES IN A PROCESS FOR PRODUCING HYDROCARBON PRODUCTS

(71) Applicant: Topsoe A/S, Kgs. Lyngby (DK)

(72) Inventor: Facundo SALA, Gentofte (DK)

(73) Assignee: Topsoe A/S, Kgs. Lyngby (DK)

(21) Appl. No.: 18/040,320

(22) PCT Filed: Aug. 13, 2021
(86) PCT No.: PCT/EP2021/072607

§ 371 Date: Feb. 2, 2023

(30) Foreign Application Priority Data
Sep. 14, 2020 (EP) 20196013.5

(51) Int. Cl. C10G 65/12

(52) U.S. Cl. CPC C10G 65/12; C10G 2300/207; C10G 2300/4081; C10G 2300/301; C10G 2400/04; C10G 2400/08; C10G 2300/4006; C10G 2300/4012

(57) ABSTRACT

Process for producing a hydrocarbon product, said process comprising: i) passing a feedstock originating from a renewable source and/or from a fossil source through a hydroprocessing step for producing a main hydrotreated stream; said hydroprocessing step comprising: passing the feedstock through one or more catalytic hydrotreating units under the addition of hydrogen for producing a first hydrotreated stream; passing the first hydrotreated stream to a first separation step comprising the use of a separation unit for particularly removing the impurities H₂S, CO, CO₂ and H₂O; withdrawing from said first separation step an overhead stream and separating an overhead hydrocarbon liquid stream thereof which is passed as a reflux stream to said first separation unit; withdrawing from said first separation step a bottom stream and passing at least a portion of said bottom stream to a dewaxing step comprising the use of one or more catalytic hydrotreating units under the addition of hydrogen for producing said main hydrotreated stream; and ii) passing the main hydrotreated stream to a second separation step for producing said hydrocarbon product.

The present invention relates to a process for producing hydrocarbons, in particular hydrocarbons boiling at above 30° C., such as jet fuel, from a feedstock originating from a renewable source and/or a fossil source, suitably wherein the fossil source represents a minor portion thereof amounting to up to 30 wt % or less of the feedstock, such as up to 10 wt %. The process comprises passing the feedstock to a hydroprocessing step comprising the use of one or more catalytic hydrotreating units and a dewaxing step, whereby in a separation step prior to the dewaxing step the content of impurities such as H₂S, H₂O, CO and CO₂, which may be detrimental to the catalysts used in the dewaxing step, is significantly reduced.

There is a growing interest to produce jet fuel or jet fuel and diesel from renewable feedstocks or by co-processing with conventional fossil fuel feedstocks. Particularly when treating renewable feedstocks, in the hydrotreating the oxygen in the feedstock is mainly removed as H₂O, which gives a paraffinic fuel consisting of paraffins with the same number for carbon atoms as in the backbone of the triglycerides. This is called the hydrodeoxygenation (HDO) pathway. Oxygen can also be removed by decarboxylation pathway, which generates CO₂ instead of H₂O:

HDO pathway: C₁₇H₃₄COOH+3.5H₂↔C₁₈H₃₈+2 H₂O

Decarboxylation pathway: C₁₇H₃₄COOH+0.5H₂↔C₁₇H₃₆+CO₂

Some renewables also contain nitrogen. Removing nitrogen also requires hydrogen, i.e. hydrodenitrification (HDN).

When producing a hydrocarbon product, particularly jet fuel, or jet and diesel, the feedstock passes through a hydroprocessing step in a hydroprocessing section. This step typically comprises HDO to obtain a hydrotreated stream which is then passed to a first separation step, normally comprising the use of a separation unit such as high pressure stripper (HP stripper) from which an overhead stream is withdrawn. This overhead stream is partly condensed and the resulting hydrocarbon liquid fraction is sent directly to a downstream dewaxing step in a dewaxing section included in the hydroprocessing step or hydroprocessing section, in which hydroisomerization and possibly a side reaction of hydrocracking occurs. After the dewaxing step the hydrotreated stream is normally passed to another separation step for producing the hydrocarbon product.

In the dewaxing step noble metal catalysts are used, which are easily contaminated and thereby impaired by impurities carried over in the hydrocarbon liquid, in particular H₂S. Other impurities may also be present, such as H₂O, NH₃, CO and CO₂. When operating with feedstocks originating from a fossil fuel source, there is a high content of sulfur, thus a hydrotreatment in the form of hydrodesulfurization (HDS) or hydrodenitrogenation (HDN) is normally conducted. When operating with feedstocks originating from a renewable source, the content of sulfur is significantly lower, thus the hydrotreatment rather comprises HDO and optionally also HDN treatment. As a result, the hydrotreated stream will contain not only H₂S, but also H₂O, NH₃, CO and CO₂ as impurities and which need to be removed prior to a downstream dewaxing step.

EP 2362892 A1 (WO 2010/053468 A1) discloses the hydroprocessing of fuel feedstocks derived from biocomponent sources, as well as hydroprocessing of blends of biocomponent and mineral fuel feedstocks. More specifically, this citation discloses a process for producing diesel fuel from biocomponent feeds which includes hydrotreating the feed followed by catalytic dewaxing. The hydrotreated feed may be cascaded directly to the dewaxing step, or the hydrotreated feed can undergo intermediate separation in a separation unit such as fractionation tower. There is no disclosure, explicit or implicit of the use of reflux in the separation unit: the use of a fractionation tower does not necessarily mean that it has a reflux, and it is clearly not the object of this citation. A reboiled column with feed to the first stage and no recycle could easily be considered a fractionation tower.

US 2002/112990 A1 discloses a process for hydroprocessing fossil fuels in two or more hydroprocessing stages wherein the liquid and vapor products from the first stage are sent to a separation zone (S) wherein a liquid phase fraction is separated from a vapor phase fraction which contains vaporized heavy hydrocarbon components. The vapor phase fraction is passed to a sorption zone (ST) under the presence of a sorption agent (STA) wherein at least a portion of the heavy hydrocarbon components is removed. Both the liquid phase fraction and the sorbed heavy hydrocarbon components are sent to at least one additional hydroprocessing stage. Optionally there is partial condensation and reflux in the sorption zone (ST) for removing the high boiling hydrocarbon components (heavy tail) from the vapor fraction. There is no stripping nor reflux in the separation zone (S), hence the impurities H₂S, H₂O, NH₃, CO and CO₂ of the bottom stream would go directly to the second hydroprocessing stage.

US 2005/167334 A1 discloses the hydrotreament of fossil fuels, in which the hydrotreament is hydro-desulphurization, hydro-denitrogenation, hydro-demetallization (to eliminate one or more metals such as vanadium, nickel, iron, sodium, titanium, silicon, copper), and hydrodearomatization. The hydrotreatment comprises at least two reaction steps with intermediate stripping of the effluent from the first step and including a reflux, each step being carried out with a hydrogen recycle loop that is exclusive to that step, thereby eliminating part of the H₂S formed. The hydrotreatment in the first reaction step does not include HDO, thus the effluent thereof does not contain additional impurities in the form of CO, CO₂ in addition to H₂O.

It is an object of the present invention to significantly reduce the content of the impurities H₂S, H₂O, NH₃, CO and CO₂ which may be in contact with the noble metal catalysts used in the dewaxing step.

This and other objects are solved by the present invention.

Accordingly, the present invention provides a process for producing a hydrocarbon product, said process comprising:
i) passing a feedstock originating from a renewable source and/or from a fossil source through a hydroprocessing step for producing a main hydrotreated stream; said hydroprocessing step comprising:
   passing the feedstock through one or more catalytic hydrotreating units under the addition of hydrogen for producing a first hydrotreated stream, e.g. a stream comprising C1-C30+ hydrocarbons, said hydrotreated stream i.e. first hydrotreated stream comprising the impurities: H₂S, NH₃, CO, CO₂ and H₂O;
   passing the first hydrotreated stream to a first separation step comprising the use of a separation unit, for removing the impurities;
   withdrawing from said first separation step an overhead stream, e.g. from said separation unit, and separating an overhead hydrocarbon liquid stream thereof of which at least a portion is passed as a reflux stream to said first separation unit;
   withdrawing from said first separation step a bottom stream, e.g. from said separation unit;
   passing at least a portion of said bottom stream to a dewaxing step comprising the use of one or more catalytic hydrotreating units under the addition of hydrogen for producing said main hydrotreated stream;
ii) passing the main hydrotreated stream to a second separation step for producing said hydrocarbon product;
wherein the one or more catalytic hydrotreating units for producing said first hydrotreated stream comprises hydrodeoxygenation (HDO) and optionally also hydrodenitrification (HDN);
wherein the one or more catalytic hydrotreating units in the dewaxing step for producing said main hydrotreated stream comprises hydrodewaxing (HDW) under the presence of a noble metal catalyst, and optionally also hydrocracking (HCR); and
wherein the entire overhead hydrocarbon liquid stream, i.e. said at least a portion of the overhead hydrocarbon liquid stream is the entire overhead hydrocarbon liquid stream, is passed as reflux stream to the separation unit.

It would be understood that the impurities are H₂S, NH₃, CO, CO₂ and H₂O, or combinations thereof. For instance, an impurity can be CO and CO₂.

The first hydrotreated stream from the catalytic hydrotreating units normally contains such impurities, which may be detrimental for the catalyst used in the subsequent dewaxing step. When operating in the so-called sweet mode, as in the present invention, the catalyst used in a catalytic hydrotreating unit (hydrodewaxing unit, HDW) of the dewaxing step is a noble metal catalyst, which is sensitive to the impurities, thereby requiring the need of using the first separation step, such as the use of a separation unit in the form of a high pressure separator or column to reduce the content of the impurities.

By the invention, instead of sending the overhead hydrocarbon liquid stream of e.g. the separation unit as part of the feed to the dewaxing step, this overhead hydrocarbon liquid stream is used as reflux to the separation unit. It has been found that the impurities, in particular H₂O, and H₂S in the feed to the dewaxing step are significantly reduced e.g. by one order of magnitude as shown in the example farther below, thereby avoiding deterioration of noble metal catalysts used therein.

The invention is particularly useful when producing jet fuel, or jet fuel and diesel. When only producing diesel, the overhead stream from the separation unit, e.g. a HP stripper, in the first separation step would normally completely bypass the catalytic hydrotreating unit in the dewaxing step, so there is no need for protecting it. At the end, it will become a small part of the whole diesel product stream, so it would be acceptable if it has not passed through the catalytic hydrotreating unit in the dewaxing step, since this will not affect the overall diesel properties.

However, the overhead stream from the separation unit in the first separation step contains some jet-boiling range components. Thus, when producing jet fuel, these components need to go through the dewaxing step in order to get them isomerized. If not, there is a risk of not reaching the jet fuel product specification, in particular specifications on the freezing point of the jet fuel. Here is where by the present invention, the overhead stream of the separation unit, for instance the HP stripper overhead stream, is withdrawn, partly condensed in e.g. an air cooler and sent to a further (cold) separator for withdrawing a condensed hydrocarbon liquid stream, i.e. an overhead hydrocarbon liquid stream. While this stream would normally be sent directly as feed to the dewaxing step, the present invention uses it as reflux to the column instead, thereby surprisingly obtaining a better overall impurity removal and consequently better protecting the catalytic hydrotreating unit(s) used in the dewaxing step.

In step ii) the main hydrotreated stream obtained from the dewaxing step is passed to a second separation step, which suitably includes the use of a separator, for instance a cold separator and a stripping section including a product stripper and a fractionator e.g. distillation column, thereby producing the hydrocarbon product, in particular jet fuel, diesel and naphtha.

In an embodiment, step ii) comprises passing said main hydrotreated stream to a separator, preferably a cold separator, for producing an aqueous stream (sour water stream), a hydrogen-rich stream, and a hydrocarbon stream which is further separated into said hydrocarbon product in a subsequent stripping section; and wherein said hydrogen-rich stream is supplied as a single recycle loop in the process by adding it to the one or more catalytic hydrotreating units for producing said first hydrotreated stream.

Thereby, a single (common) recycle loop for the recycling of hydrogen is provided, so that the hydrogen-rich gas from the cold separator can be added to not only e.g. the HDO step prior to the first separation step, but optionally also to the dewaxing step after the first separation step. A single hydrogen recycle compressor is needed instead of separate recycle compressors and additional piping for independent addition of hydrogen to the HDO or dewaxing step.

In an embodiment, the process further comprises adding said hydrogen-rich stream to the dewaxing step comprising the use of one or more catalytic hydrotreating units for producing said main hydrotreated stream.

In another embodiment, said hydrogen-rich stream is not added to the dewaxing step. Instead, a make-up hydrogen gas, e.g. from outside sources, is added to the dewaxing step. The make-up hydrogen gas, after passing through the dewaxing step, is suitably mixed with the hydrogen-rich stream (recycle gas) and then conducted as a single recycle gas loop, back to the HDO step. In other words, according to this embodiment, the process further comprises: not adding the hydrogen-rich stream to the dewaxing step, adding a make-up hydrogen gas, e.g. from outside sources, to the dewaxing step, and after passing it through the dewaxing step, mixing with the hydrogen-rich stream thus generating a mixed hydrogen stream, which is then supplied as said single recycle loop. It is advantageous to use only make-up hydrogen gas because, contrary to the hydrogen-rich stream, the make-up hydrogen gas is basically pure H₂ and thus free of contaminants.

In an embodiment, the process further comprises: separating an overhead gaseous stream comprising the impurities from said overhead stream from the first separation step, and passing said overhead gaseous stream, suitably after mixing it with said main hydrotreated stream and suitably also by subsequently cooling in e.g. an air cooler, to said separator in step ii).

Thereby, the impurities, such as H₂S and NH₃ are carried over and withdrawn with the sour water stream withdrawn from the separator, e.g. a cold separator, while at the same time said single (common) recycle loop for the recycling of hydrogen is provided. Further integration, simplicity and flexibility in the process is thus achieved.

In an embodiment, said hydrocarbon product boils at above 30° C. and comprises one or more of: jet fuel, diesel, naphtha and optionally also lube base stock (base oil for lubes). In a particular embodiment said hydrocarbon is jet fuel, or jet fuel and diesel.

By the invention, the entire overhead hydrocarbon liquid stream of the first separation step, e.g. from the separation unit, is passed as reflux stream to the separation unit.

Accordingly, a full reflux is provided, i.e. the entire overhead hydrocarbon liquid stream is used. The term “entire”, as used herein, means 95 wt % or more of the overhead hydrocarbon liquid stream, suitably 100 wt %. Thereby, there is full reflux of the overhead hydrocarbon liquid stream and the only feed to the dewaxing step is the one coming from the bottom of the first separation step, e.g. from the separation unit, hence further increasing the removal of the impurities, e.g. up to one order of magnitude or more for some of the impurities, more specifically for H₂O and H₂S.

It would be understood, that when there is full reflux, the bottom stream from the first separation step, in particular the bottom stream from the separation unit is the stream that passes to the dewaxing step.

It would also be understood, that if there is no full reflux, but partial reflux, a purified first hydrotreated stream is optionally formed by combining the bottom stream from the first separation step, in particular the bottom stream from the separation unit, with the portion of the overhead liquid stream that is not refluxed. The purified first hydrotreated stream will then be passed to the dewaxing step. The at least a portion of the bottom stream from the first separation step, in particular of the bottom stream from the separation unit, and the portion of the overhead liquid stream that is not refluxed, may be passed individually i.e. without combining these streams, to the dewaxing step.

In an embodiment of the invention, said hydrocarbon product boils at above 30° C. and comprises one or more of: jet fuel, diesel, naphtha and optionally also lube base stock. Suitably the hydrocarbon product is jet fuel, or jet fuel and diesel.

In an embodiment of the invention, in the first separation step the separation unit is a high-pressure stripper (HP stripper). A HP stripper is also referred as HP stripping column.

HP strippers are well known in the art. A HP stripper provides optimal removal of the impurities. Stripping media for the HP stripper can be make-up hydrogen gas i.e. hydrogen-rich make-up gas, separator off-gas e.g. hot separator off-gas, or nitrogen. A HP stripper may for instance operate in the pressure range 40-70 barg and the temperature range 150-250° C.

In an embodiment, the first separation step further comprises using a hot separator upstream the separation unit.

The liquid from the hot separator is sent to the downstream separation unit e.g. a HP stripper, thereby increasing flexibility and refinement of the stripping step in the process.

A hot separator, as is well known in the art, is a two-phase or three-phase vertical or horizontal separator, most commonly two-phase, with a gas stream from the top and a liquid stream from the bottom, running at a temperature above 100° C., whereby water is removed as vapor in said gas stream. A hot separator can operate at high, medium or low pressure, for instance in the range 1-70 barg.

It would be understood, that the term “hot separator” refers to when water is removed as vapor. The term “cold separator” refers to when water is removed as liquid.

By the invention at least a portion of said bottom stream is passed to a dewaxing step. In an embodiment, in step i) a recycle oil stream is divided from said bottom stream, e.g. the bottom stream of the first separation step (from the high-pressure stripper) and passed to the one or more catalytic hydrotreating units upstream, i.e. catalytic hydrotreating units for producing said first hydrotreated stream.

The recycle oil is used as a diluent to reduce the exothermicity of the hydrotreating due to the use of, in particular, a feedstock of renewable origin. A renewable feedstock is more reactive than typical hydrocarbon feedstocks based on fossil fuels. The renewable feedstock contains sulfur and in particular more oxygen, the reactions of which to respectively form H₂O and H₂S, are more exothermic. Thereby, higher integration, flexibility, efficiency and not least safety in the process is achieved.

In an embodiment, the one or more catalytic hydrotreating units for producing said first hydrotreated stream is hydrodeoxygenation (HDO) and hydrodenitrification (HDN).

As used herein, HDO encompasses also decarboxylation.

The material catalytically active in hydrotreating, typically comprises an active metal (sulfided base metals such as nickel, cobalt, tungsten and/or molybdenum, but possibly also either elemental noble metals such as platinum and/or palladium) and a refractory support (such as alumina, silica or titania, or combinations thereof).

Hydrotreating conditions involve a temperature in the interval 250-400° C., a pressure in the interval 30-150 bar, and a liquid hourly space velocity (LHSV) in the interval 0.1-2, optionally together with intermediate cooling by quenching with cold hydrogen, feed or product.

In an embodiment, the dewaxing step comprises using hydrodewaxing (HDW) under the presence of a noble metal catalyst, and optionally also hydrocracking (HCR).

In the dewaxing step, the wax content is reduced by isomerization under isomerization conditions and optionally also cracking, under the presence of hydrogen. Hence, as used herein, the term hydrodewaxing (HDW) is used interchangeably with the term hydroisomerization (HDI)

The material catalytically active in hydrodewaxing typically comprises an active metal (either elemental noble metals such as platinum and/or palladium), an acidic support (typically a molecular sieve showing high shape selectivity, and having a topology such as MOR, FER, MRE (more specifically MRE*), MWW, AEL, TON and MTT) and a refractory support (such as alumina, silica or titania, or combinations thereof).

Isomerization (HDI) conditions involve a temperature in the interval 250-400° C., a pressure in the interval 20-100 bar, and a liquid hourly space velocity (LHSV) in the interval 0.5-8, optionally together with intermediate cooling by quenching with cold hydrogen, feed or product.

The material catalytically active in hydrocracking is of similar nature to the material catalytically active in isomerization, and it typically comprises an active metal (either elemental noble metals such as platinum and/or palladium or sulfided base metals such as nickel, cobalt, tungsten and/or molybdenum), an acidic support (typically a molecular sieve showing high cracking activity, and having a topology such as MFI, BEA and FAU) and a refractory support (such as alumina, silica or titania, or combinations thereof). The difference to material catalytically active isomerization is typically the nature of the acidic support, which may be of a different structure (even amorphous silica-alumina) or have a different acidity e.g. due to silica:alumina ratio. It would be understood, that in the context of the present invention, there may also be a difference in the nature of the metals, e.g. the metals for HDW comprise a noble metal catalyst such as platinum, while the metals for hydrocracking may comprise a base metal such as nickel and/or molybdenum.

Hydrocracking conditions involve a temperature in the interval 250-400° C., a pressure in the interval 30-150 bar, and a liquid hourly space velocity (LHSV) in the interval 0.5-8, optionally together with intermediate cooling by quenching with cold hydrogen, feed or product.

In an embodiment, the feedstock originating from a renewable source is obtained from a raw material of renewable origin, such as originating from plants, algae, animals, fish, vegetable oil refining, domestic waste, waste rich in plastic, industrial organic waste like tall oil or black liquor, or a feedstock derived from one or more oxygenates taken from the group consisting of triglycerides, fatty acids, resin acids, ketones, aldehydes or alcohols where said oxygenates originate from one or more of a biological source, a gasification process, a pyrolysis process, Fischer-Tropsch synthesis, or methanol based synthesis.

In an embodiment, the feedstock originating from a fossil fuel source is diesel, kerosene, naphtha, and vacuum gas oil (VGO).

Optionally, recycling of hydrocarbon product generated in the process, such as said recycle oil stream in step i), is provided as part of the feedstock.

The invention provides for the use of a feedstock originating from a renewable source, or a feedstock originating from a fossil fuel source, or a combination thereof i.e. co-processing. In an embodiment, the feedstock originates from a renewable source and from a fossil source, and wherein the fossil source represents a minor portion thereof amounting to up to 30 wt % or less of the feedstock, such as up to 10 wt %.

A 100% renewable feedstock i.e. a feedstock originating from a renewable source with e.g. no co-feed of a feedstock from a fossil fuel source, or where the latter only represents a minor portion as recited above, contains significantly less sulfur than a pure fossil fuel feedstock, and requires a hydrotreatment comprising HDO to remove oxygen from the renewable feed, thus resulting in not only H₂S, but significantly higher concentrations of the other impurities H₂O, NH₃, CO and CO₂.

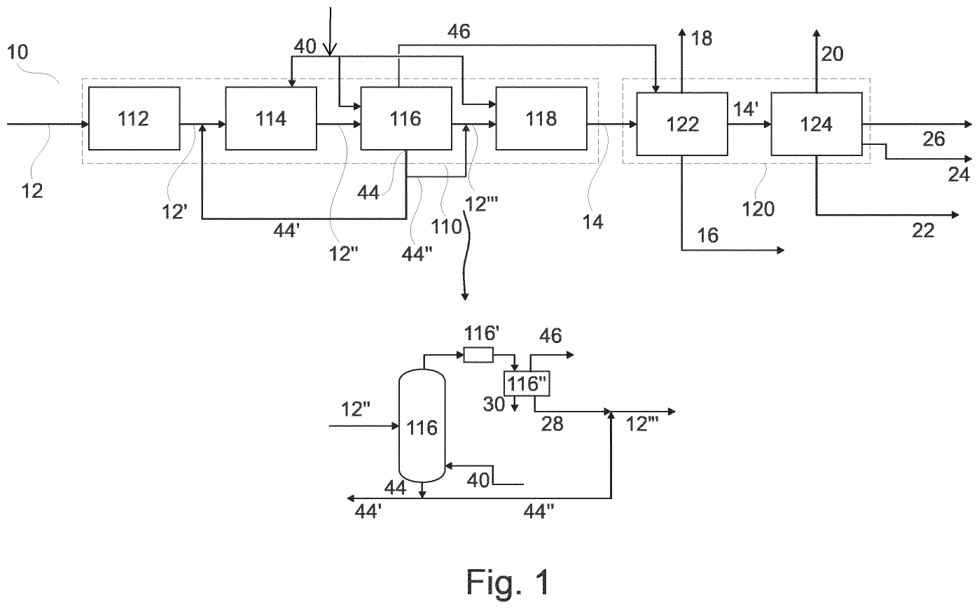

FIG. 1 shows a schematic process and plant layout for producing naphtha, jet and diesel from a feedstock, according to the prior art. The figure includes an expanded view of the separation unit used in the first separation step.

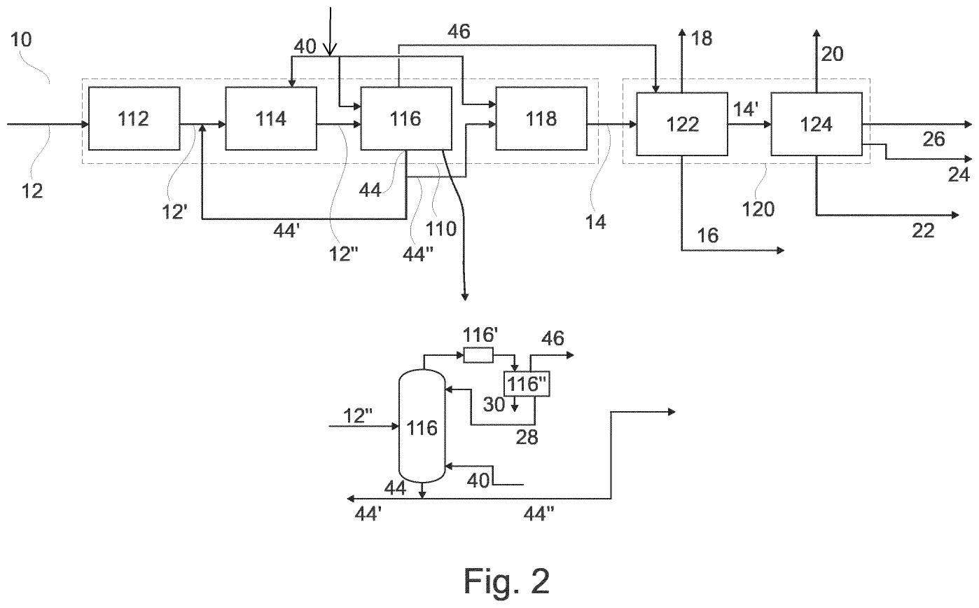

FIG. 2 shows a schematic process and plant layout for producing naphtha, jet and diesel from a feedstock, according to an embodiment of the invention. The figure includes an expanded view of the separation unit used in the first separation step.

With specific reference to FIG. 1, a block flow diagram of the overall process/plant 10 is shown. A feedstock 12, such as a feedstock originating from a renewable source, is fed to the hydroprocessing step or hydroprocessing section 110. This step or hydroprocessing section comprises an optional feed step or feed section 112 and a reactor section including a catalytic hydrotreating unit 114 such as HDO, dewaxing step or dewaxing section 118, as well as a first separation step 116, here illustrated by the use of a separation unit 116 in the form a HP stripper. From the hydroprocessing step 110, in particular from the dewaxing step 118, a main hydrotreated stream 14 is produced, which is then passed to a second separation step 120, which produces: aqueous (water) stream 16; off-gas stream 20 comprising hydrocarbons such as light hydrocarbon stream, also comprising NH₃, CO, CO₂ and H₂S; and hydrocarbon products in the form of diesel 22, jet fuel 24 and naphtha 26.

After optionally passing the feedstock 12 through the optional feed step 112, the feedstock 12′ passes through a catalytic hydrotreating unit 114 such as HDO wherefrom a first hydrotreated stream 12″ is withdrawn. This stream is then passed to the HP stripper 116 under the production of a vapor stream 46 i.e. an overhead gaseous stream comprising a major portion of the impurities, a bottom stream 44 from which recycle oil stream 44′ is divided as well as a stream 44″ which is combined with overhead liquid stream from HP stripper 116 thereby forming a purified first hydrotreated stream 12′″. The latter enters a dewaxing step 118 comprising the use of a catalytic hydrotreating unit, HDW unit 118, for producing the main hydrotreated stream 14. An additional catalytic hydrotreating unit in the form of a hydrocracking unit (HCR unit) may also be provided for instance downstream or upstream the HDO or HDW unit for respectively producing the first hydrotreated stream 12″ or main hydrotreated stream 14.

The second separation step 120 includes the use of a separator 122, preferably a cold separator, and a stripping section 124 including a product stripper and a fractionator e.g. distillation column (not shown). Overhead gaseous stream 46 generated in the previous HP stripper 116 may be used e.g. mixed with the main hydrotreated stream 14 for the operation of separator 122. From the separator 122, hydrogen-rich stream 18 is withdrawn which may be used as hydrogen gas recycle, for instance by mixing with streams 12′ and 44′ entering catalytic hydrotreating unit 114, as well as the separator 122 also generating the above-mentioned water stream 16. The impurities are thus carried over into said water stream 16 (sour water stream). From the separator 122, a hydrocarbon stream 14′ is produced which is then fed to the stripping section 124 under the production of off-gas stream 20 comprising hydrocarbons, as well as the hydrocarbon products diesel 22, jet fuel 24 and naphtha 26. Make-up hydrogen gas 40 e.g. from outside battery limits, is added to the HP stripper 116, and optionally also to the catalytic units 114, 118 of the hydroprocessing step 110.

An expanded schematic view of the HP stripper 116 is also provided in FIG. 1. Stream 12″ is for instance fed to the first tray of HP stripper 116. The HP stripper overhead stream, as shown in the figure, is withdrawn and partly condensed in e.g. an air cooler 116′ and sent to a separator 116″ for withdrawing a condensed hydrocarbon liquid stream, i.e. an overhead hydrocarbon liquid stream 28, as well as sour water stream 30 and vapor stream 46. The overhead hydrocarbon liquid stream 28 is sent as feed to the dewaxing step 118 optionally after combining with the bottom stream 44″ withdrawn from the HP stripper 116. Make-up hydrogen gas 40 is used in the stripping and recycle oil stream 44′ is divided from the bottom stream 44 of the HP stripper 116 and passed to the one or more catalytic hydrotreating units 114 upstream.

Now with reference to FIG. 2, which shows an embodiment according to the invention, the block flow diagram of the overall process/plant 10 is identical to that of FIG. 1, except that stream 44″ divided from the bottom stream 44 from the HP stripper 116 is the only hydrocarbon feed to the dewaxing step 118.

The expanded schematic view of the HP stripper 116 shows now the use of the overhead liquid stream 28 as reflux to the HP stripper instead. As illustrated herein, the entire overhead hydrocarbon liquid stream 28 is passed as reflux, thereby surprisingly obtaining a significant improvement in the overall impurity removal and consequently better protecting the catalytic hydrotreating unit(s) in the dewaxing step 118.

From the separator 122, preferably a cold separator, a hydrogen-rich stream 18 is withdrawn which may be used as hydrogen gas recycle, and which is suitably supplied as a single recycle loop in the process, i.e. the hydrogen-rich stream 18 is added to the one or more catalytic hydrotreating units 114 for producing the first hydrotreated stream 12″.

### EXAMPLE

Prior Art:

In accordance with FIG. 1, the level of impurities in the liquid phase to the dewaxing step or dewaxing section 18 before any heating, is as follows:

H₂O: 1589 wppb, NH₃: 14 wppb, H₂S: 1528 wppb, CO+CO₂: 3798 wppb.

Invention:

In accordance with FIG. 2, the entire overhead hydrocarbon liquid stream 28 is passed as reflux to the HP stripper 116, i.e. full reflux. The same operating conditions in the HP stripper (pressure, temperature, stripping gas flow) as for FIG. 1 are used. The level of impurities in the liquid phase to the dewaxing step or dewaxing section 18 before any heating, is now as follows:

H₂O: 136 wppb, NH₃: 9 wppb, H₂S: 124 wppb, CO+CO₂: 1197 wppb

A surprisingly high reduction in the level of the impurities, particularly H₂S, H₂O and/or CO+CO₂ is thereby achieved. A reduction of about one order of magnitude is obtained for H₂S and H₂O.

1. A process for producing a hydrocarbon product, said process comprising:
i) passing a feedstock originating from a renewable source and/or from a fossil source through a hydroprocessing step for producing a main hydrotreated stream; said hydroprocessing step comprising:
passing the feedstock through one or more catalytic hydrotreating units under the addition of hydrogen for producing a first hydrotreated stream, said hydrotreated stream comprising the impurities: H₂S, NH₃, CO, CO₂ and H₂O;
passing the first hydrotreated stream to a first separation step comprising the use of a separation unit, for removing the impurities;
withdrawing from said first separation step an overhead stream and separating an overhead hydrocarbon liquid stream thereof of which at least a portion is passed as a reflux stream to said first separation unit;
withdrawing from said first separation step a bottom stream;
passing at least a portion of said bottom stream to a dewaxing step comprising the use of one or more catalytic hydrotreating units under the addition of hydrogen for producing said main hydrotreated stream; ii) passing the main hydrotreated stream to a second separation step for producing said hydrocarbon product;
wherein the one or more catalytic hydrotreating units for producing said first hydrotreated stream comprises hydrodeoxygenation (HDO)
wherein the one or more catalytic hydrotreating units in the dewaxing step for producing said main hydrotreated stream comprises hydrodewaxing (HDW) under the presence of a noble metal catalyst;
and wherein the entire overhead hydrocarbon liquid stream is passed as reflux stream to the separation unit.

2. The process according to claim 1, wherein step ii) comprises passing said main hydrotreated stream to a separator, for producing an aqueous stream (sour water stream), a hydrogen-rich stream, and a hydrocarbon stream which is further separated into said hydrocarbon product in a subsequent stripping section; and wherein said hydrogen-rich stream is supplied as a single recycle loop in the process by adding it to the one or more catalytic hydrotreating units for producing said first hydrotreated stream.

3. The process according to claim 2, further comprising: not adding the hydrogen-rich stream to the dewaxing step; adding a make-up hydrogen gas to the dewaxing step, and after passing it through the dewaxing step, mixing it with the hydrogen-rich stream thus generating a mixed hydrogen stream, which is then supplied as said single recycle loop.

4. The process according to claim 2, further comprising: separating an overhead gaseous stream comprising the impurities from said overhead stream from the first separation step, and passing said overhead gaseous stream, suitably after mixing it with said main hydrotreated stream and suitably also by subsequently cooling, to said separator in step ii).

5. The process according to claim 1, wherein said hydrocarbon product boils at above 30° C. and comprises one or more of: jet fuel, diesel, and naphtha.

6. The process according to claim 1, wherein in the first separation step, the separation unit is a high-pressure stripper, suitably in the form of a stripping column using make-up hydrogen gas as stripping medium and operating in the pressure range 40-70 barg and temperature range 150-250° C.

7. The process according to claim 1, wherein the first separation step further comprises using a hot separator upstream the separation unit, suitably in the form of a two-phase or three-phase vertical or horizontal-separator, whereby water is removed as vapor in said gas stream.

8. The process according to claim 1, wherein in step i) a recycle oil stream is divided from said bottom stream and passed to the one or more catalytic hydrotreating units upstream.

9. The process according to claim 1, wherein the feedstock originating from a renewable source is obtained from a raw material of renewable origin.

10. The process according to claim 1, wherein the feedstock originating from a fossil fuel source is selected from diesel, kerosene, naphtha, and vacuum gas oil (VGO).

11. The process according to claim 1, wherein the feedstock originates from a renewable source and from a fossil source, and wherein the fossil source represents a minor portion thereof amounting to up to 30 wt % or less of the feedstock, such as up to 10 wt %.

12. The process according to claim 1, wherein the one or more catalytic hydrotreating units for producing said first hydrotreated stream further comprises hydrodenitrification (HDN).

13. The process according to claim 1, wherein the one or more catalytic hydrotreating units in the dewaxing step for producing said main hydrotreated stream further comprises hydrocracking (HCR).

14. The process according to claim 1, wherein the separator in step ii) comprises a cold separator.

15. The process according to claim 2, wherein the make-up hydrogen gas is from outside sources.

16. The process according to claim 2, wherein the subsequently cooling is provided by an air cooler.

17. The process according to claim 1, wherein the hydrocarbon product further comprises lube base stock.

18. The process according to claim 1, wherein the two-phase or three-phase vertical or horizontal separator is two-phase, with a gas stream from the top and a liquid stream from the bottom, running at a temperature above 100° C.

19. The process according to claim 1, wherein the feedstock originating from a renewable source is obtained from the raw material of renewable origin originating from plants, algae, animals, fish, vegetable oil refining, domestic waste, waste rich in plastic, industrial organic waste like tall oil or black liquor.

20. The process according to claim 1, wherein the feedstock originating from a renewable source is obtained from a feedstock derived from one or more oxygenates taken from the group consisting of triglycerides, fatty acids, resin acids, ketones, aldehydes or alcohols where said oxygenates originate from one or more of a biological source, a gasification process, a pyrolysis process, Fischer-Tropsch synthesis, or methanol based synthesis.
